(19) United States
(12) Patent Application Publication
(10) Pub. No.: US 2005/0055283 A1
(43) Pub. Date: Mar. 10, 2005

(54) System and method for processing product orders

(76) Inventor: Adolph Zarovinsky, Richmond Hill (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/952,865

(22) Filed: Sep. 30, 2004

Related U.S. Application Data
(63) Continuation of application No. 09/809,308, filed on Mar. 16, 2001.

(51) Int. Cl. G06F 17/60

(52) U.S. Cl. 705/26

(57) ABSTRACT

The present invention is a computer-based system and method for processing orders over the Internet. In one embodiment, the method of the present invention comprises the steps of identifying a customer placing a product order, displaying information relating to other orders associated with the customer, receiving details of a new product order from the customer, confirming details of the new product order from the customer, determining the date on which the products ordered is to be delivered to the customer, and sending order information to at least one supplier associated with the product order. Preferably, some or all of the steps of the method are performed in real-time.

### FIELD OF THE INVENTION

This invention relates generally to a system and method for processing orders. More specifically, this invention relates to an Internet-based system and method for processing product orders and facilitating the tracking of these orders.

### BACKGROUND OF THE INVENTION

The use of the Internet by consumers to purchase goods and services from merchants is widespread. A web-based interface is commonly provided by such merchants to allow consumers to browse through descriptions of goods (or services) offered by the merchant, and to place purchase orders for selected goods (or services). The orders are then processed by the merchant, typically in the order in which they are received, a delivery date is established, and subsequently, the goods (or services) are delivered to a location specified by the customer (e.g. to the customer's home).

The use of Internet-based systems by retailers to purchase goods and services from their suppliers in a similar manner (i.e. business-to-business systems) is less common. Particularly in industries where retailers require products from their suppliers on a “just-in-time” basis, comprehensive Internet-based ordering systems are generally not in common usage.

For example, consider a retail grocery store or restaurant which sells food products having a very short shelf life (e.g. 24-48 hours). These products may include, for example, bakery goods, salads, fresh soups, dairy products, and others. Typically, an employee of the retail grocery store or restaurant would contact one or more food suppliers by telephone to place an order for the products, specifying a date of delivery and a delivery receiving location.

If the food products being ordered are “made-to-order”, the food products are typically prepared by the food supplier that day, and the products subsequently delivered to the retail grocery store or restaurant on the following day. In preparing the order, the food supplier may require other components, perishable and non-perishable, (including for example, meats, fruits, vegetables, etc.) that it must obtain from its own suppliers to complete the order. These components must also be ordered by and delivered to the food suppliers in a very short period of time.

Several problems can arise in the context of the typical processing of perishable food product orders. In some cases, food suppliers will wait until the end of the day after receiving the day's orders from manufacturers, wholesalers, retail grocery stores, restaurants, or other customer establishments, before ordering components needed to fulfill the orders from the suppliers' own suppliers (referred to in this specification as the suppliers' “component providers”). This delays the processing of orders since the orders cannot be completed until the requisite components are received.

One solution would be to warehouse components that a supplier anticipates may be required to complete any orders that it might receive from its customers. However, this results in additional costs to manage and store the inventory. Furthermore, the supplier will likely be expected to absorb the costs of any spoiled goods, and thus it may not be feasible to warehouse certain components, particularly perishables with a very short shelf life.

Alternatively, an automated Electronic Data Interchange (EDI) computer system could be used to facilitate the provision of components from component providers to suppliers, or from suppliers to the suppliers' customers. The system can be designed to allow one party to be automatically notified when goods or supplies are required by another party. The system may be linked to a party's inventory or point-of-sale systems to facilitate monitoring of what goods or components may be required by a party at any one time.

However, these prior art EDI systems are typically closed systems, where a private communications link between the component provider and supplier, or supplier and customer, must be pre-established. Further, the appropriate hardware and software components must be purchased and installed by both parties. In some cases, this may be prohibitively expensive. Further, these systems are not typically used where the turnaround time of orders is relatively short (e.g. 24-48 hours), as they are in the preparation of certain foods or other perishable goods.

Many of the above prior systems are not adapted to perform other tasks beyond the placing and tracking of orders, such as providing information to customers such as advertising, product information, order statistics, or instructions relating to the preparation or use of products, for example. Many of these systems are also highly complex, not user-friendly, and difficult to operate without significant training.

Another problem with some prior art product ordering systems is that they are not programmed to warn a customer when a potentially duplicate order submitted from the same merchant is pending (for example, when an employee of a customer attempts to make the same order previously entered by another employee of the same customer). Often, when a supplier becomes aware of a duplicated order, the supplier bears the costs associated with having already partially or fully completed the duplicate orders.

Accordingly, there is a need for a system and method for processing orders which addresses at least some of the disadvantages of prior art product ordering systems and methods.

### SUMMARY OF THE INVENTION

In one aspect, the invention provides for a method of processing product orders over the Internet comprising identifying the customer placing a product order, displaying information relating to other orders associated with the customer, receiving details of the product order from the customer, requesting confirmation of the product order from the customer, determining the date on which the products ordered will be delivered to the customer, and sending order information to at least one supplier.

In another aspect of the invention, the method of processing product orders over the Internet also includes arranging for the delivery of products associated with the product order to a delivery receiving location.

In another aspect of the invention, the method of processing product orders over the Internet also includes coordinating the collection of products from at least two suppliers, for subsequent delivery to a delivery receiving location.

The present invention also provides for a system for processing product orders over the Internet comprising an order processing module, databases containing order information, customer information, product information, and supplier information, and a web-based interface adapted to receive input from a customer.

### BRIEF DESCRIPTION OF THE DRAWINGS

For a better understanding of the present invention, and to show more clearly how it may be carried into effect, reference will now be made by way of example, to the accompanying drawings which show a preferred embodiment of the present invention, and in which:

FIG. 1 is a schematic diagram illustrating the system of the present invention;

FIG. 2 is a flow chart illustrating the steps performed in the processing of an order;

FIG. 3 is a flow chart illustrating the steps performed in a method of performing administrative tasks; and

FIGS. 4 to 13 are examples of screens displayed in the processing of a product order received from a customer.

### DETAILED DESCRIPTION OF THE PREFERRED EMBODIMENT

The present invention is directed to an online ordering and tracking system for goods and services, and a method of receiving and tracking orders received from a customer. In the preferred embodiment, the system and method of the present invention is used to receive product orders from a business establishment such as a restaurant or grocery store, for perishables that have a relatively short shelf life. The shelf life of such perishables is generally less than 72 hours, often less than 48 hours, and typically between 24 to 48 hours. The present invention can then be used to facilitate the expeditious completion of these orders by one or more suppliers of products for the business establishment.

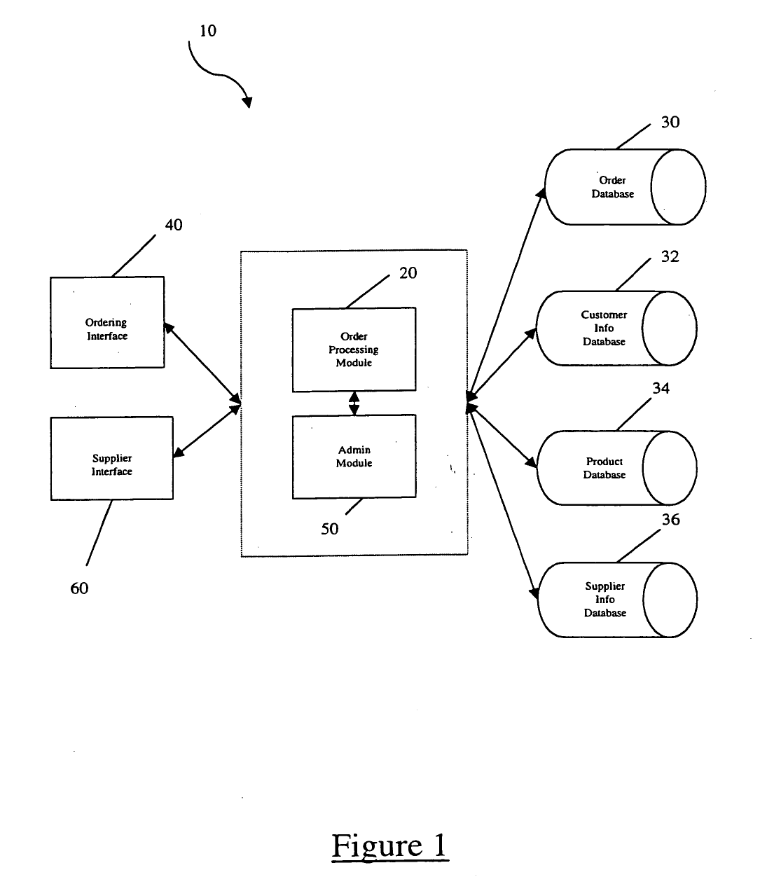

Referring to FIG. 1, a system for processing product orders is shown generally as 10. System 10 comprises several components: an order processing module 20, an order database 30, a customer information database 32, a product database 34, a supplier information database 36, and an ordering interface 40 which is preferably web-based.

Preferably, system 10 also comprises an administration module 50 and a supplier interface 60 which is preferably web-based. The components of system 10 may reside, for example, on a web server (not shown).

The order processing module 20 processes product orders received from customers using information retrieved from the various databases. For example, order database 30 stores information received with respect to an order being entered, and can also store information on past orders including outstanding orders, orders currently being processed, previously processed orders, and details of any orders pending submission by a customer and saved in the system 10. Data can be read from the order database 30 by the order processing module 20 for display in the ordering interface 40. Data can also be written to the order database 30 by the order processing module 20 when information pertaining to the order is received from the customer through the ordering interface 40.

The customer information database 32 stores information pertaining to the customers who have been registered by the operator of system 10 to place product orders using the system 10. Preferably, system 10 also includes an administration module 50 that creates new customer records for the customer information database 32, and performs administration and registration functions including obtaining new customer information from the customer through the ordering interface 40, associating a user name and password with the customer, communicating this information to the customer through the ordering interface 40, and processing changes to the information in the customer information database 32 as required. Alternatively, such changes may be similarly processed by the order processing module 20, for example.

The information in the customer information database 32 is accessed by the order processing module 20 to confirm customer contact information and delivery receiving location, and is used when arranging for delivery of the order to the delivery receiving location.

The product database 34 stores information pertaining to the products available to customers for ordering. The information in the product database 34 is accessed by the order processing module 20 when information on a product is requested by a customer through the ordering interface 40. Information relating to the preparation or use of available products, or nutritional information relating to the products, may also be stored in the product database 34. The product database 34 may be connected to the administration module 50, allowing the administration module 50 to process changes to the information stored in the product database 34 using input obtained from a supplier interface 60. Alternatively, such changes may instead be processed by order processing module 20 for example, and the input for such changes may be obtained from the supplier interface 60.

The supplier information database 36 stores information pertaining to suppliers registered in the system 10. Preferably, the administration module 50 is programmed to create new supplier records for the supplier information database 36, and to perform supplier registration functions including obtaining information from the supplier through a supplier interface 60 and processing changes to the information in the supplier information database 36 as required. Alternatively, such changes may be similarly processed by the order processing module 20, for example.

The ordering interface 40 is preferably web-based, allowing customers to access the system 10 via the Internet, thus providing a convenient mechanism for the input of information to the system 10 by the customer, and for the output of information from the system 10 to the customer. The ordering interface 40 can be designed to have a “look-and-feel” similar to web interfaces with which employees of the customer may already be familiar. A closed or private network connection between the customer and a supplier need not be pre-established.

Similarly, the supplier interface 60 is also preferably web-based, allowing suppliers to access the system 10 via the Internet. This provides a convenient mechanism for the input of information to the system 10 by a supplier, and the output of information from the system 10 to a supplier.

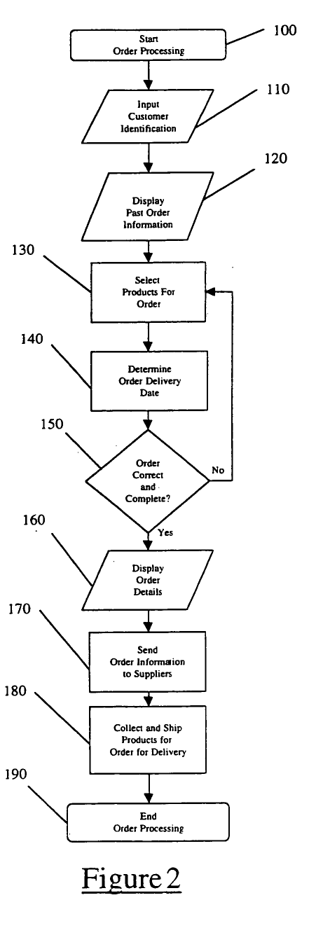

Referring to FIG. 2, a method for processing product orders is shown as a series of steps commencing at step 100.

At step 110, a product order is initiated by a customer through the ordering interface 40 of system 10. The customer is prompted to enter customer identification information, which may include, for instance, a user identifier and a password. Other possible customer identification information may include one or more customer identifiers, a requested level of security (e.g., encryption strength) to be associated with the documents to be subsequently viewed in the customer's browser, and a desired method of document display (e.g., frames, no-frames). This information is then processed by the order processing module 20, which identifies the customer requesting access to the system 10 by comparing the customer information received as input to the information stored in the customer information database 32.

Preferably, the order processing module 20 subsequently prompts the customer through the ordering interface 40 to confirm the information pertaining to the customer currently stored in the customer information database 32. This may include, for example, customer contact information and a default delivery receiving location (i.e. where ordered products are to be delivered). Where more than one employee is associated with a particular customer, particulars relating to the specific employee may also be displayed and made subject to confirmation.

At step 120, optionally, past order information can be retrieved from the order database 30 by the order processing module 20, for display to the customer through the ordering interface 40. Preferably, this past order information will include, for example, information on orders associated with the customer which are outstanding but have not been processed, and information on orders associated with the customer which are currently being processed. In both cases, this allows an employee of a customer to determine whether he, or another employee has previously placed an identical or similar order as the order about to be placed. This prevents inadvertent duplicate orders and places the responsibility of ensuring that duplicate orders are not made on the customer rather than the operator of the system 10. If the system 10 is designed to allow only one employee of a specific customer to access the system 10 at any one time, this provides even better assurance that a duplicate order will not be inadvertently made.

Providing information on recently placed orders also allows for the tracking of those orders. The order processing module 20 can be programmed to provide to the customer more detailed status information (e.g., percent completion, whether the order is ready for delivery, whether the order has already been delivered) on an order for this purpose.

Past order information may also include previously processed orders and orders saved in the system 10 (“saved orders”). Saved orders can include orders that have been entered by a customer but which the customer has chosen to postpone the processing of. Saved orders can also include repeat orders which are orders that the customer places on a frequent basis. Advantageously, by allowing customers to save their repeat orders, the processing of orders is made more efficient since it is not necessary to re-enter all the required information pertaining to the repeat order. Furthermore, so long as the saved order is initially entered correctly, the occurrence of subsequent data entry errors or product reference errors that may occur in re-entering repeat orders can be effectively eliminated, and therefore makes the placing of new orders much easier.

A customer on reviewing past order information (as in step 120 of FIG. 2) may also be permitted to cancel an order already placed.

At step 130, products are selected by the customer which are to comprise the order. Product information can be displayed to the customer if requested by the customer. Similarly, other information including information relating to the preparation or use of a product or nutritional information, for example, may also be accessed by the customer. Product information is preferably stored in the product database 34.

Products available for selection may be displayed in a list, and each product may be optionally identified with a symbol, icon, graphic, or the like to distinguish the identified product from others in the list. For example, available “new” products, products on “special”, or discounted products may be so identified.

Products available for selection displayed in the list may also be accompanied by other related product information, including product identifiers, an indication of the size, weight, quantity, or price of the product comprising a single order of that product, and/or other information.

Preferably, the order processing module 20 is programmed to allow each customer to view only information which that customer is authorized to view, and to order only products which that customer is authorized to order. For example, a customer may only be registered to purchase products from a specific set of suppliers. Means for controlling what information a specific customer is authorized to view can include, for example, a user identifier and password system, or some other type of permission-based control system. Accordingly, the order processing module 20 can be programmed to list only products from those suppliers for display to the customer in the ordering interface 40.

Furthermore, advantageously, system 10 is designed to prevent one customer from gaining unauthorized access to information pertaining to other customers, unless specifically permitted by the administrator of the system 10.

Similarly, the order processing module 20 can be programmed to allow an employee of a customer to view only information which that specific employee is authorized to view, and to order only products which that employee is authorized to order. For example, while a supervisor may be permitted to order any product from an authorized supplier, other employees may be restricted to ordering products not having a unit price in excess of a specified amount, or they may be restricted to ordering products of a specific type, or from a specific group or category. Accordingly, the order processing module 20 can be programmed to list the products that the employee placing the order is authorized to select from in the ordering interface 40.

It will be appreciated by those skilled in the art that there are numerous possible ways of defining which products can be ordered by a specific customer or employee of a customer, and that the order processing module 20 can be programmed to display a subset of products for which data is stored in the product database 34 to the specific customers or employee in a variety of manners and formats.

After the products pertaining to the order are selected by the customer, this information is submitted to the order processing module 20 for further processing.

Alternatively, a customer may manually request that a saved order, a repeat order or the previous order be processed. These types of orders may also automatically be generated and processed by system 10 if so desired.

At step 140, a delivery date for the order is determined by the order processing module 20. Using specified turnaround times of the products being ordered (e.g., as stored in product database 34), the order processing module 20 determines the date at which the order can be delivered to the customer at a designated delivery receiving location. Alternatively, several choices for order delivery dates and/or delivery receiving locations may be displayed. An order delivery date and/or delivery receiving location can then be subsequently selected by a customer. The order processing module 20 may also provide the customer with a date and time after which the order may not be cancelled by the customer.

At step 150, the order processing module 20 asks for confirmation from the customer that the order is correct and complete. If the customer indicates that the order is not correct and complete, the flow of method steps proceeds back to step 130 where the details of the order may be changed. Otherwise, the flow of method steps proceeds to step 160.

At step 160, an order summary is provided to the customer by the order processing module 20. Information on the order including, for example, order delivery date and delivery receiving location can be shown. Additionally, order processing module 20 may assign an order confirmation identifier, which can be used, for example, to facilitate the tracking of orders as they are being fulfilled. Information pertaining to the current order is stored by the order processing module 20 in the order database 30.

At step 170, order information is sent by the order processing module 20 to the supplier (or suppliers) of the products selected by the customer in the current order. Suppliers may be instructed to deliver their products directly to the customer's delivery receiving location, or to deliver products to a central order processing location on or before a collection date (on or before the order delivery date) specified by the order processing module 20.

Preferably, each of the above steps are performed in real-time. This is particularly preferable where the products being ordered are perishable, or where replenishment of goods is required by customers on very short notice.

At step 180, the products ordered by the customer are delivered to the customer at the designated delivery receiving location, preferably on the order delivery date. The order or a part thereof may be fulfilled by one supplier, and the associated products may be delivered directly by that supplier to the customer. Alternatively, all products comprising the order may first be collected at a central order processing location, having being received from one or more suppliers, and subsequently delivered together to the customer at the designated delivery receiving location, preferably on the order delivery date.

Step 190 marks the end of the method of processing product orders.

In the above method, the order delivery date may be, more specifically, a date and a time at which the order is estimated to be delivered to the designated delivery receiving location.

Advantageously, the automated nature of system 10 allows for orders to placed without the need for a human order taker, thus allowing orders to be placed 24 hours a day, seven days a week or as otherwise desired. Further, the automated nature of system 10 reduces the need to re-enter repeat orders, thus minimizing the likelihood that inaccurate references to desired products, quantity of products desired, or product delivery requirements will be made.

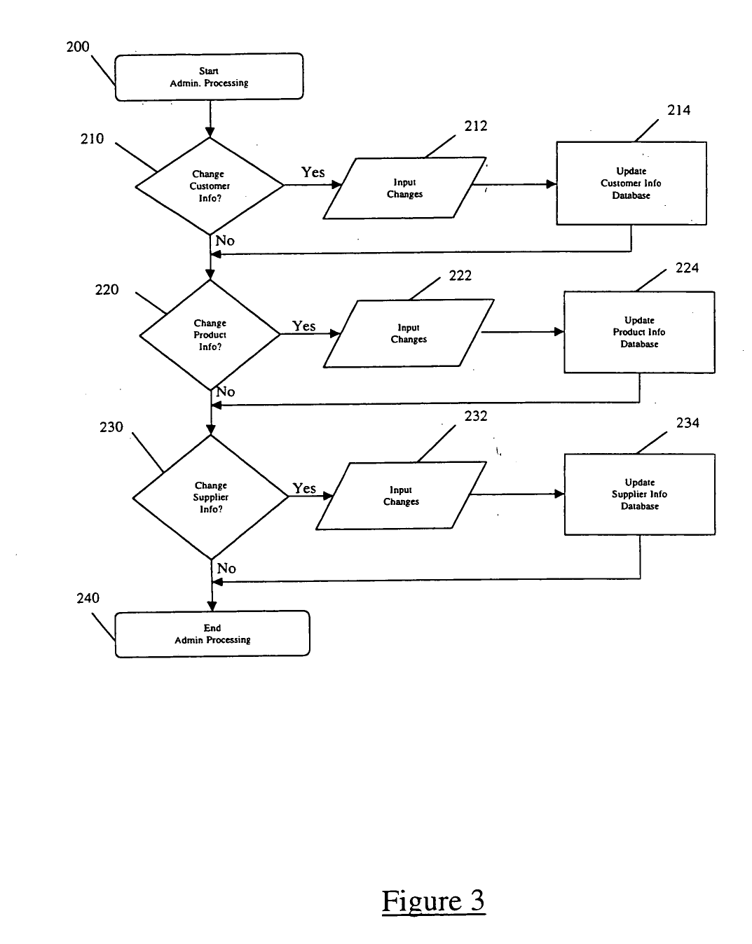

Referring to FIG. 3, a method for processing administrative tasks is shown as a series of steps commencing at step 200. The steps of this method may be performed upon a request from a customer to review and amend his customer information through the ordering interface 40, or at the request of a supplier to review and amend his supplier information, or information on the products he supplies, through the supplier interface 60.

At step 210, administration module 50 determines if a customer is requesting a change to the information as stored in the customer information database 32, which is retrieved from the customer information database 32 and displayed to the customer through the ordering interface 40 by the administration module 50. Optionally, the administration module 50 may also determine if the customer is authorized to make such changes (e.g., by checking an authorization level associated with the customer which can be pre-specified during the registration of a customer). If the customer information is to be changed, the flow of method steps proceeds to step 212 where the administration module 50 prompts the customer to input changes through the ordering interface 40, and subsequently at step 214, the customer information database 32 is updated accordingly, and the flow of method steps proceeds to step 220. Otherwise, if changes to customer information are not required or authorized, the flow of method steps proceeds directly to step 220.

At step 220, the administration module 50 determines if a supplier is requesting changes to information pertaining to products associated with that supplier, as retrieved from the product database 34 and displayed to the supplier through the supplier interface 60. If changes to the product information need to be made, the flow of method steps proceeds to step 222 where details of the changes are inputted by the supplier through the supplier interface 60, after which the flow of method steps proceeds to step 224 where the product database 34 is updated accordingly, and the flow of method steps proceeds to step 230. Otherwise, if no changes to the product information are required, the flow of method steps proceeds directly to step 230.

At step 230, the administration module 50 determines if a supplier is requesting changes to his supplier information, as stored in the supplier information database 36 and displayed to the supplier through the supplier interface 60. If changes to the supplier information are required, the flow of method steps proceeds to step 232 where details of the changes are inputted by the supplier through the supplier interface 60, after which the flow of method steps proceeds to step 234 where the supplier information database 36 is updated accordingly, and the flow of method steps proceeds to step 240. Otherwise, if no changes to the supplier information are required the flow of method steps proceeds directly to step 240.

Step 240 marks the end of the method for processing administrative tasks.

Preferably, all steps of FIG. 3 are performed in real-time.

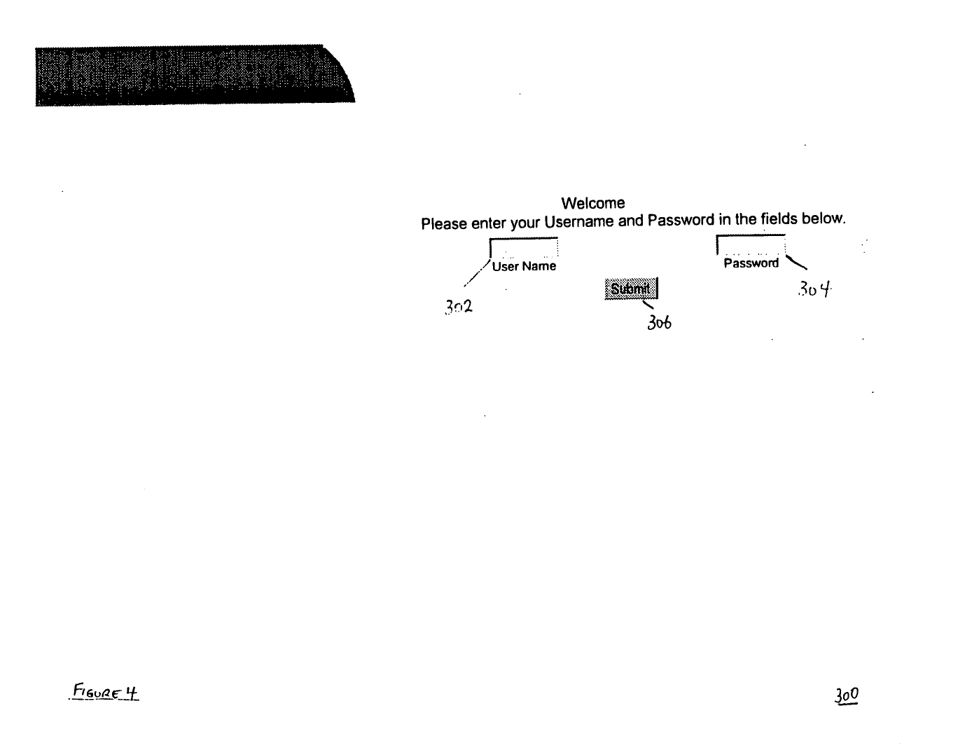

Examples of screens seen in an ordering interface 40 during the processing of an order are illustrated in FIGS. 4 through 13. Preferably, the ordering interface is web-based (i.e. it permits users to access the system using the Internet).

Referring to FIG. 4, an example of a login screen 300 is shown where a customer is prompted to input customer identification information to permit the order processing module 20 to identify him. The login screen 300 may comprise several input fields including, for example: a user name field 302 and a password field 304. Buttons required to initiate various tasks may also be included in the login screen 300, including, for example, a button 306 that submits information in the input fields to the order processing module 20 of system 10.

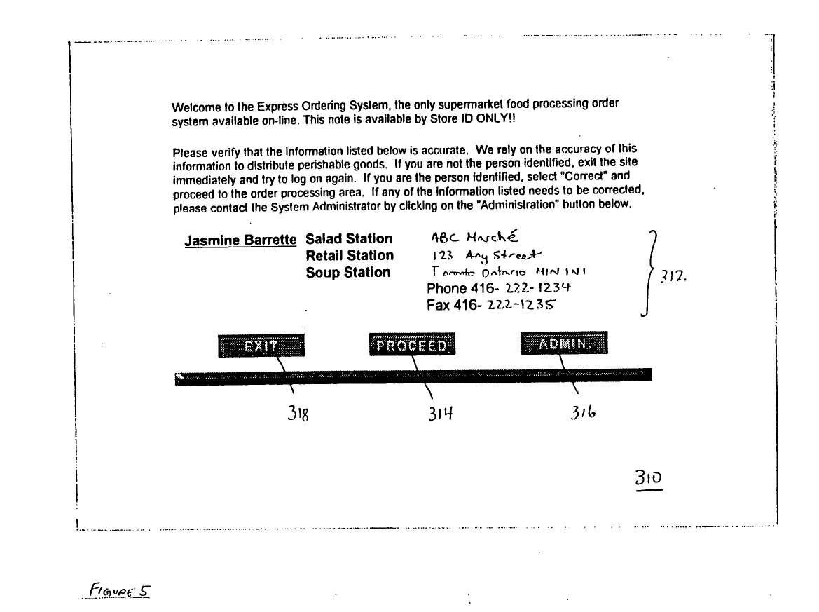

Referring to FIG. 5, an example of an identification confirmation screen 310 is shown where information pertaining to the customer as shown in customer information field 312 is shown. The customer confirmation screen 310 may also comprise several buttons which can be selected by the customer to initiate various tasks. For example, a “proceed” button 314 can be selected by a customer to indicate that the information customer information field 312 is correct, an “administration” button 316 can be selected to request a change to the information in customer information field 312 (e.g., causing the method of FIG. 3 to be performed), and an “exit” button 318 can be selected to request that the customer be logged out of the system 10.

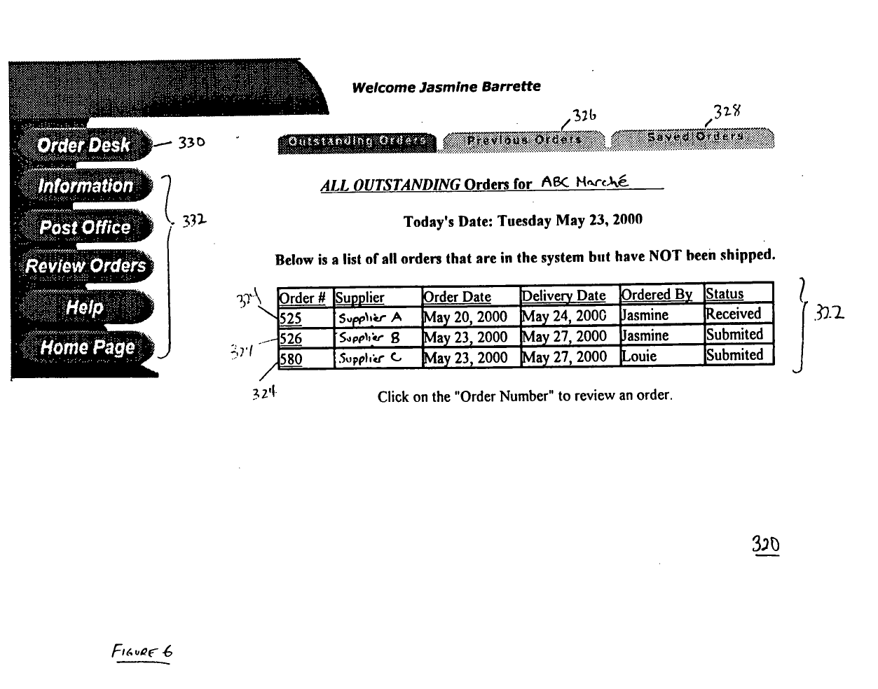

Referring to FIG. 6, an example of an outstanding orders screen 320 is shown. All outstanding orders and the status of these orders are displayed in output field 322. Each outstanding order is identified by an order number 324. The order may be selected by the customer to request a review of its particulars. By selecting a “previous orders” button 326 or a “saved orders” button 328, other past orders may be reviewed. An “order desk” button 330 may also be provided to place an order. Other buttons 332 may also be included to allow a customer to initiate various different tasks.

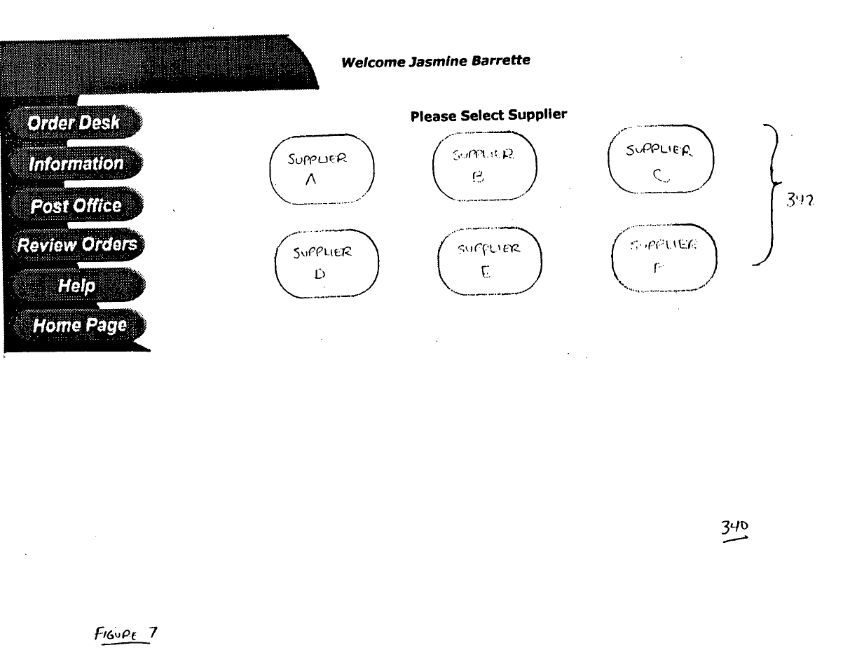

Referring to FIG. 7, an example of a set of suppliers represented by supplier buttons 342 may be displayed for selection by the customer, upon initiating an order placement by clicking the order desk button 330 of FIG. 6.

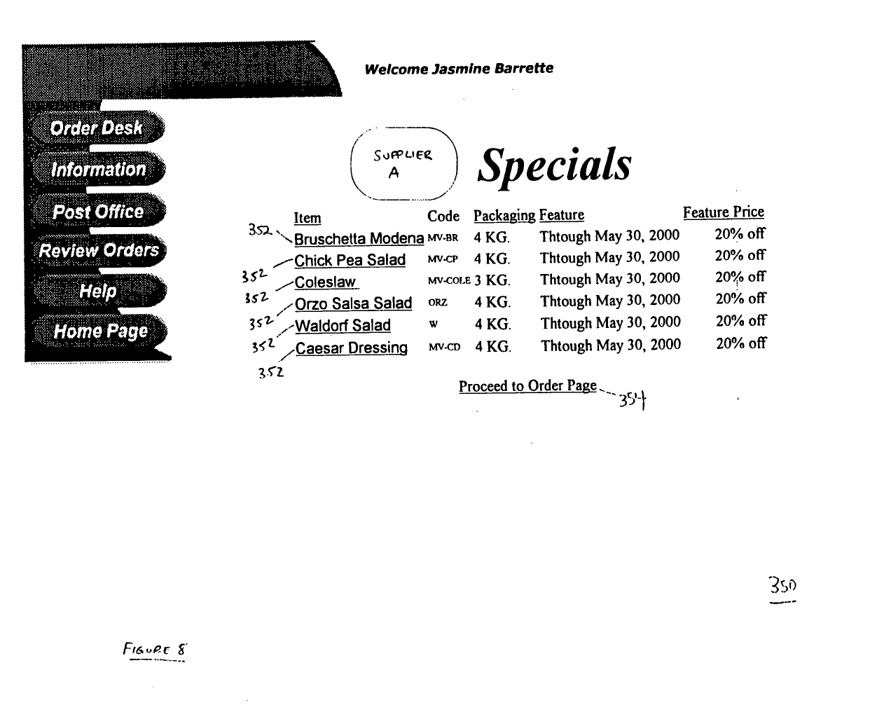

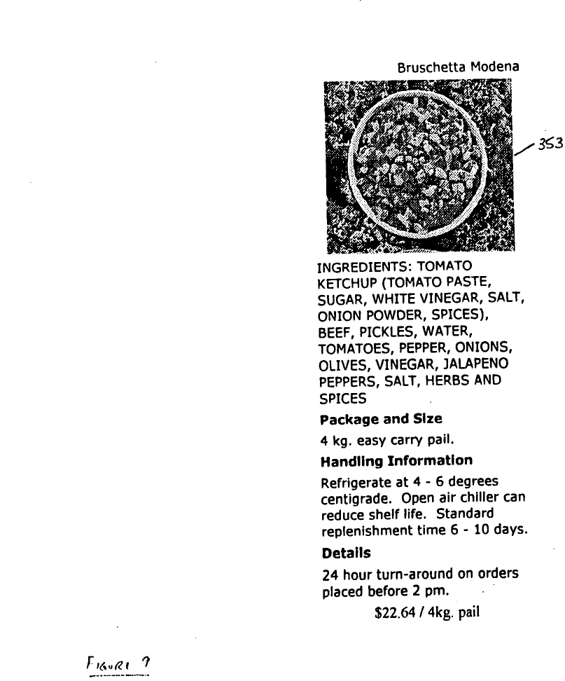

Referring to FIG. 8, an example list of “specials” (for example, discounted products, promotional offerings, etc.) specific to the selected supplier is shown. Product names 352 are shown in the list of “specials”, and each product name 352 may be selected to request information on that product, such as that shown in FIG. 9 for example. Such information may include, for example, a picture of the product 353 (FIG. 9), information on the use and preparation of the product, ingredients or nutritional information pertaining to the product of the product, and other information. A button or link 354 allows the user to proceed to an order page.

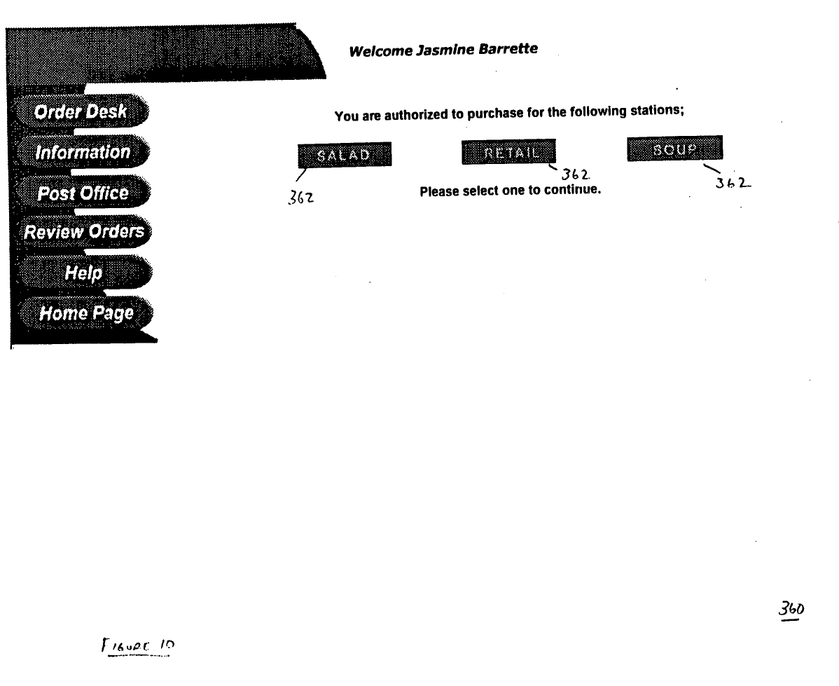

Referring to FIG. 10, an example list of product categories 360 for which the customer, or more specifically, the employee of the customer currently accessing the system, is authorized to purchase is shown. Buttons 362 pertaining to the various product categories may be selected to proceed with the ordering process.

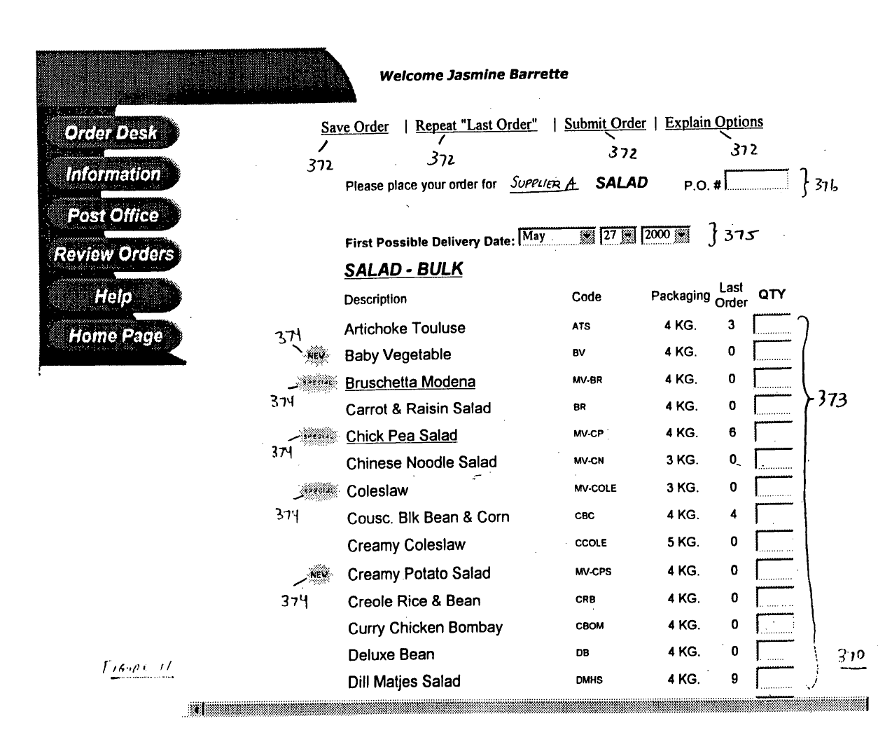

Referring to FIG. 11, a portion of an example order screen 370 is shown. Buttons or links 372 may be selected to perform various tasks, including the saving of a current order, a request to repeat the last order, a request to submit the current order, and others. A list 373 of products available for ordering is provided. One or more product names may be selected to request information on that product. A product may be further identified by a graphic 374 which may be used to indicate new products or discounted products, for example. Input fields are defined and used to enter order information including, for example, the quantity of products desired. Data fields 375 made available to the customer on the order screen 370 permit delivery dates to be selected.

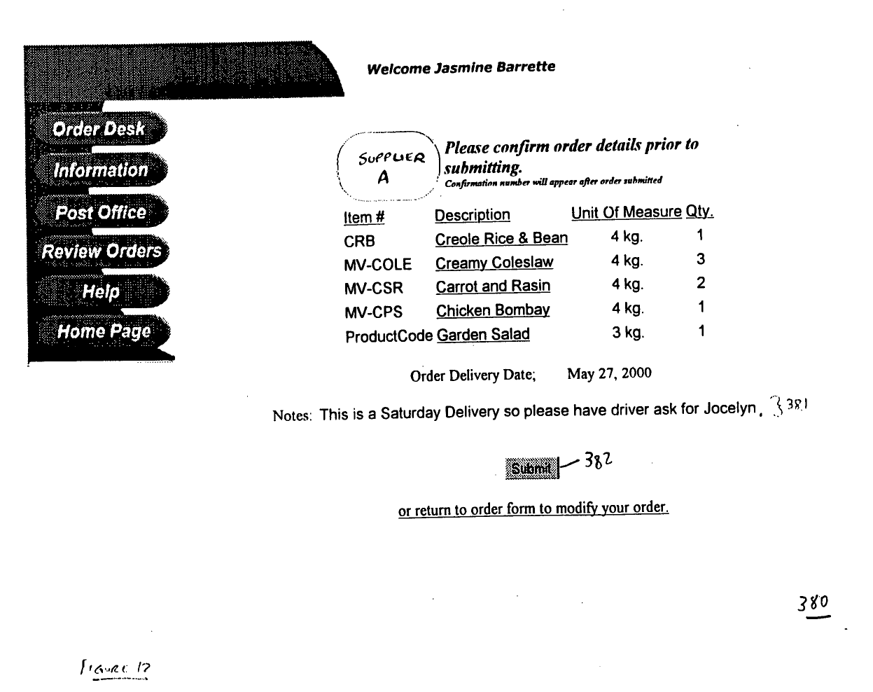

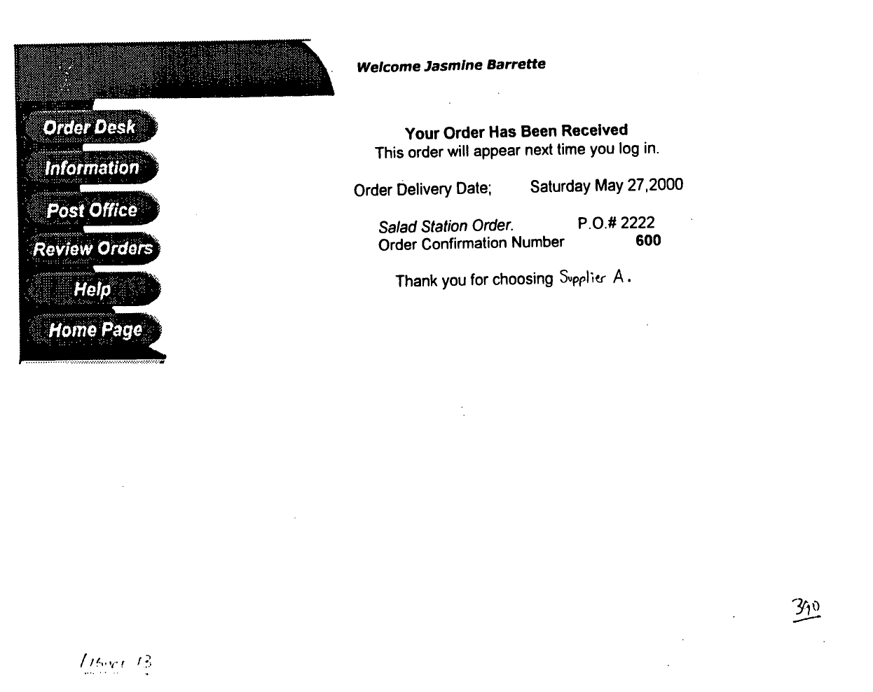

Referring to FIG. 12, an example order confirmation screen 380 is shown. Subsequently upon pressing a “submit” button 382, a summary screen 390 as shown in the example of FIG. 13 can be displayed to the customer.

In variant embodiments of the invention, the order processing module 20 may be programmed to allow for the entering of an order by only one employee associated with a customer at a time using known methods, thus preventing simultaneous access to the system 10 through the ordering interface 40 by multiple employees of the same customer.

In variant embodiments of the invention, the order processing module 20 may, in displaying information to the customer through the ordering interface 40, also display promotional or advertising material in the ordering interface 40.

In variant embodiments of the invention, the order processing module 20 may permit the customer, supplier, or operator of the system 10 to review statistical information related to orders placed by a customer or group of customers.

In variant embodiments of the invention, the order processing module 20 can provide information regarding an order received, to a supplier by means of electronic mail, facsimile transmission, telephone, or any printed or electronic means, as an alternative to providing that information through a supplier interface 60.

In variant embodiments of the invention, the method of processing an order, may also comprise a step where a service fee is charged to a customer for placing an order using the system 10.

In variant embodiments of the invention, the method for processing product orders may also comprise a step where a service fee (e.g. commission or referral fee) is charged to the supplier of a product ordered by a customer through the system 10.

In variant embodiments of the invention, the system 10 can include a messaging or communication component that may be adapted to allow communication, in real-time or otherwise, between buyers and/or suppliers registered in the system 10. This may include the capability of sending electronic mail or text messages to other buyers and/or suppliers, or the provision of a “bulletin board” service.

In variant embodiments of the invention, the order processing module 20 may also be programmed to automatically send order information to specified component providers used by participating suppliers, thereby further integrating order fulfilment across several supplier levels and facilitating the real-time processing of product orders.

In variant embodiments of the invention, the interfaces 40 and 60 of system 10 need not be Internet-based, but may instead be interfaces in a private, closed or internal network. Alternatively, some interfaces of the system 10 may be Internet-based, while other interfaces may be connected to the components of system 10 through private, closed or internal network connections.

In variant embodiments of the invention, the orders being processed by system 10 may not be restricted to product orders, but may also include orders for services, or orders for a combination of products and services.

With respect to the elements of the system 10 for the processing of product orders described in 'this specification, it will be apparent to those skilled in the art that the execution of various tasks associated with the processing of an order need not be performed by the particular component specified in the description of the preferred and variant embodiments of the invention. For example, it will be obvious to those skilled in the art that the performance of tasks by the order processing module 20 may be performed by a different module, or multiple modules. As a further example, the steps performed by the administration module 50 may instead be performed by the order processing module 20, or other module(s). It will also be obvious to those skilled in the art that the information stored in each of the order database 30, customer information database 32, product database 34, and supplier information database 36, may be distributed across a larger number of storage means. Alternatively, the data of two or more of these databases or portions thereof may be combined for storage into one or more storage means.

As will be apparent to those skilled in the art, other various modifications and adaptations of the system and methods described herein are possible without departing from the present invention, the scope of which is defined in the claims.

1. A method of processing orders over the Internet, the method comprising:
(a) identifying a customer;
(b) receiving details of a new product order from the customer;
(c) confirming details of the new product order with the customer;
(d) determining a date on which ordered products are to be delivered to the customer; and
(e) sending information pertaining to the new product order to at least one supplier.

2. The method of processing orders over the Internet as claimed in claim 1, wherein the method also comprises:
(f) arranging for the delivery of products associated with the new product order to a delivery receiving location designated by the customer.

3. The method of processing orders over the Internet as claimed in claim 2, wherein the method also comprises the step of coordinating the collection of a plurality of products from a plurality of suppliers for subsequent delivery to said delivery receiving location.

4. The method of processing orders over the Internet as claimed in claim 1, wherein the method also comprises displaying details pertaining to at least one of the following: outstanding orders, orders being processed, previously processed orders, saved orders.

5. The method of processing orders over the Internet as claimed in claim 4, wherein said saved orders include repeat orders.

6. The method of processing orders over the Internet as claimed in claim 1, wherein said method also comprises at least one of the following steps: displaying advertising material, displaying order statistics, displaying product information, displaying information relating to the preparation or use of products.

7. The method of processing orders over the Internet as claimed in claim 1, wherein said method also comprises selecting at least one product from at least one group of products, and wherein the customer may only select products that the customer has been pre-authorized to select.

8. The method of processing orders over the Internet as claimed in claim 1, wherein step (e) is performed by at least one of the following: electronic mail, fax, telephone, any printed means, any electronic means.

9. The method of processing orders over the Internet as claimed in claim 8, where step (e) is performed in real-time.

10. The method of processing orders over the Internet as claimed in claim 8, wherein the method also comprises the step of communicating details pertaining to the product order to at least one component provider of the at least one supplier.

11. The method of processing orders over the Internet as claimed in claim 1, wherein all the steps comprising the method are performed in real-time.

12. The method of processing orders over the Internet as claimed in claim 1, wherein the method also comprises charging a fee to the customer.

13. The method of processing orders over the Internet as claimed in claim 1, wherein the method also comprises charging a fee to at least one supplier.

14. The method of processing orders over the Internet as claimed in claim 1, wherein the method also comprises displaying status information on an order for tracking purposes.

15. A system for processing orders over the Internet, said system comprising:
(a) an order processing module for providing order information to at least one supplier;
(b) at least one database connected to said order processing module, wherein said at least one database contains order information, customer information, product information, and supplier information; and
(c) a user interface connected to said order processing module for receiving input from a customer.

16. The system for processing orders over the Internet as claimed in claim 15, wherein the user interface is a web-based interface.

17. The system for processing orders over the Internet as claimed in claim 15, wherein said system also comprises an administration module connected to said order processing module.

18. The system for processing orders over the Internet as claimed in claim 15, wherein said system also comprises a communications module adapted to permit users of the system to communicate with one another.

19. A system for processing product orders made by a customer over the Internet, the system comprising:
(a) output means for viewing previously entered product orders;
(b) input means for entering a new product order and selecting an order delivery date and an delivery receiving location; and
(c) processing means for communicating details of said new product order to at least one supplier and coordinating the delivery of at least one product to said delivery receiving location.

20. The system for processing product orders made by a customer over the Internet as claimed in claim 19, wherein said customer is a grocery store or restaurant.

21. The system for processing product orders made by a customer over the Internet as claimed in claim 20, wherein said new product order comprises an order for at least one product typically having a shelf life of less than 72 hours.

22. The system for processing product orders made by a customer over the Internet as claimed in claim 21, wherein said new product order comprises an order for at least one product typically having a shelf life of between 24 and 48 hours.

23. The system for processing product orders made by a customer over the Internet as claimed in claim 19, wherein said method also comprises display means for displaying at least one of the following: advertising, order statistics, product information, information relating to the preparation or use of products.

24. The system for processing product orders made by a customer over the Internet as claimed in claim 19, wherein said method also comprises tracking means for tracking said previously entered product orders.

25. A method of processing product orders over the Internet, the method comprising:
(a) identifying a customer;
(b) displaying details pertaining to at least one outstanding orders, orders being processed, previously processed orders, saved orders;
(c) receiving details of a new product order from the customer;
(d) confirming details of the new product order with the customer;
(e) determining a date on which ordered products are to be delivered to the customer;
(f) sending information pertaining to the new product order to at least one supplier; and
(g) arranging for the delivery of products associated with the new product order to a delivery receiving location as designated by the customer.

26. The method for processing product orders over the Internet as claimed in claim 25, wherein said customer is a grocery store or restaurant.

27. The method for processing product orders over the Internet as claimed in claim 26, wherein said new product order comprises an order for at least one product typically having a shelf life of less than 72 hours.

28. The method for processing product orders over the Internet as claimed in claim 27, wherein said new product order comprises an order for at least one product typically having a shelf life of between 24 and 48 hours.

29. The method of processing product orders over the Internet as claimed in claim 25, wherein said method also comprises at least one of the following steps: displaying advertising material, displaying order statistics, displaying product information, displaying information relating to the preparation or use of products.

30. The method of processing product orders over the Internet as claimed in claim 25, wherein said method also comprises displaying status information on an order for tracking purposes.
